(19) United States
(12) Patent Application Publication
(10) Pub. No.: US 2010/0303439 A1
(43) Pub. Date: Dec. 2, 2010

(54) METHOD AND SYSTEM FOR LOOK DATA DEFINITION AND TRANSMISSION

(75) Inventors: Ingo Tobias Doser, Villingen-Schwenningen (DE); Rainer Zwing, VS-Villingen (DE); Wolfgang Endress, Villingen-Schwenningen (DE)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 12/735,527

(22) PCT Filed: Jan. 31, 2008
(86) PCT No.: PCT/IB2008/000224

§ 371 Date: Jul. 23, 2010

(51) Int. Cl. H04N 9/80

(52) U.S. Cl. 386/239; 386/E09.001

(57) ABSTRACT

A method and system for generating look data for video content include a generator for generating look data for a scene of the video content. In one embodiment, the look data includes at least one control parameter for affecting at least one display attribute of the respective scene of the video content. The method and system further include a transmission preparation device for generating at least one look data packet from the look data, the at least one look data packet intended to be delivered with the video content to enable the at least one look data packet to be applied to the video content such that when the at least one look data packet is applied to the video content, the at least one display attribute of the video content is changed in accordance with the at least one control parameter of the at least one look data packet.

### CROSS-REFERENCE TO RELATED APPLICATIONS

This application is related to the non-provisional application, Attorney Docket No. PU070306, entitled “Method and System for Look Data Definition and Transmission over a High Definition Multimedia Interface (HDMI)”, which is commonly assigned, incorporated by reference herein in its entirety, and currently filed herewith.

### FIELD OF THE INVENTION

The present principles generally relate to multimedia interfaces and, more particularly, to a method and system for look data definition and transmission.

### BACKGROUND OF THE INVENTION

Currently, when delivering a video content product either for home use or for professional use, there is one singular color decision made for that video delivery product, which is typically representative of the video content creators intent. However, different usage practices of the content may occur so that the content's color decision may have to be altered. For instance, such different usage practices may involve different display types such as a front projection display, a direct view display, or a portable display, each requiring some change to the color decision to provide an optimal display of such video content.

Moreover, another consideration is that content production time windows are continually shrinking, and it would be ultimately beneficial if it was possible to change the look of one scene, several scenes, or the whole feature film late in the production stage, perhaps even after most of the content authoring is done, or even later, after the content has entered the market.

### SUMMARY OF THE INVENTION

A method and system in accordance with various embodiments of the present invention address the deficiencies of the prior art by providing look data definition and transmission.

In one embodiment of the present invention, a method for generating look data for video content includes generating look data for a scene or sequence of scenes of the video content, where the look data includes at least one control parameter for affecting at least one display attribute of the respective scene or sequence of scenes of the video content and generating at least one look data packet from the look data, the at least one look data packet intended to be delivered with the video content to enable the at least one look data packet to be applied to the video content. The method can further include delivering the video content and the at least one look data packet to a display system, where a content rendering device of the display system applies the at least one look data packet to the video content to change the at least one display attribute of the video content in accordance with the at least one control parameter of the at least one look data packet.

In an alternate embodiment of the present invention, a system for generating look data for video content include a generator for generating look data for a scene of the video content, the look data including at least one control parameter for affecting at least one display attribute of the respective scene of the video content. The system further includes a transmission preparation device for generating at least one look data packet from the look data, the at least one look data packet intended to be delivered with the video content to enable the at least one look data packet to be applied to the video content such that when the at least one look data packet is applied to the video content, the at least one display attribute of the video content is changed in accordance with the at least one control parameter of the at least one look data packet.

### BRIEF DESCRIPTION OF THE DRAWINGS

The teachings of the present principles can be readily understood by considering the following detailed description in conjunction with the accompanying drawings, in which:

FIG. 1 depicts a high level block diagram of a system 100 for transmitting look data, in accordance with an embodiment of the present invention;

FIG. 2 depicts a more detailed high level block diagram further illustrating the system 100 of FIG. 1 using sequential look data transmission, in accordance with an embodiment of the present invention;

FIG. 3 depicts a more detailed high level block diagram further illustrating the system 100 of FIG. 1 using parallel look data transmission, in accordance with an embodiment of the present invention;

FIG. 4 depicts a flow diagram of a method for look data definition and transmission in accordance with an embodiment of the present invention;

FIG. 5 depicts an exemplary representation of look data 500, in accordance with an embodiment of the present invention;

FIG. 6 depicts exemplary KLV notation of metadata 600 for use in Look Data Elementary Messages, in accordance with an embodiment of the present invention;

FIG. 7 depicts the KLV notation of metadata 600 of FIG. 6 in further detail, in accordance with an embodiment of the present invention;

FIG. 8 depicts an exemplary Look Data Elementary Message 800 implemented as a 3D-LUT with a bit depth of 8 bits, in accordance with an embodiment of the present invention;

FIG. 9 depicts an exemplary Look Data Elementary Message 900 implemented as a 3D-LUT with a bit depth of 10 bits, in accordance with an embodiment of the present invention;

FIG. 10 depicts an exemplary Look Data Elementary Message 1000 implemented as a 1D-LUT with a bit depth of 8 bits, in accordance with an embodiment of the present invention;

FIG. 11 depicts an exemplary Look Data Elementary Message 1100 implemented as a 1D-LUT with a bit depth of 10 bits, in accordance with an embodiment of the present invention;

FIG. 12 depicts, an exemplary Look Data Elementary Message 1200 implemented as a 3×3 matrix with a bit depth of 8 bits, in accordance with an embodiment of the present invention;

FIG. 13 depicts an exemplary Look Data Elementary Message 1300 implemented as a 3×3 matrix with a bit depth of 10 bits, in accordance with an embodiment of the present invention;

FIG. 14 depicts an exemplary Look Data Elementary Message 1400 implemented as a 3×3 matrix with a bit depth of 16 bits, in accordance with an embodiment of the present invention;

FIG. 15 depicts an exemplary filter bank 2400 for frequency response modification, in accordance with an embodiment of the present invention;

FIG. 16 depicts discrete frequencies 1600 for frequency equalization, in accordance with an embodiment of the present invention;

FIG. 17 depicts an exemplary Look Data Elementary Message 1700 for 8 bit frequency equalization, in accordance with an embodiment of the present invention;

FIG. 18 depicts an exemplary Look Data Elementary Message 1800 for motion behavior, in accordance with an embodiment of the present invention;

FIG. 19 depicts an exemplary Look Data Elementary Message 1900 for film grain, in accordance with an embodiment of the present invention;

FIG. 20 depicts an exemplary Look Data Elementary Message 2000 for noise, in accordance with an embodiment of the present invention;

FIG. 21 depicts an exemplary Look Data Elementary Message 2100 for time editing capable of being used for editorial control, in accordance with an embodiment of the present invention; and

FIG. 22 depicts an exemplary Look Data Elementary Message 2200 for tone mapping, in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of the present invention advantageously provide a method and system for look data definition and transmission. Although the present principles will be described primarily within the context of a transmission system relating to a source device and a display device, the specific embodiments of the present invention should not be treated as limiting the scope of the invention.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared.

Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown

It is to be appreciated that the terms “transmission”, “transmitting”, “transmission medium”, and so forth as used herein are intended to include and refer to any type of data conveyance approach. For example, such terms, although including various versions of the word “transmit”, are nonetheless intended to include, bit are not limited to, at least one of the following: data transmission and data carrier mediums. Thus, for example, such terms may involve the use of one or more of the following: wired devices and/or wired mediums; wireless devices and/or wireless mediums; storage devices and/or storage mediums; and so forth. Thus, as examples, such terms may involve at one of the following: cables (Ethernet, HDMI, SDI, HD-SDI, IEEE1394, RCA, S-video, and/or etc.); WIFI; BLUETOOTH; a standard digital video disc; a high definition digital video disc; a BLU-RAY digital video disc; a network(s); a network access unit (for example, including, but not limited to, a set top box (STB)); and/or so forth.

Moreover, as used herein, with respect to the transmission and receipt of look data, the phrase “in-band” refers to the transmitting and/or receiving of such look data together with the color corrected picture content to be displayed by a consumer device. In contrast, the phrase “out-of-band” refers to the transmitting and/or receiving of the look data separately with respect to the color corrected picture content to be displayed by a consumer device.

Further, as used herein, the term “scene” refers to a range of picture frames in a motion picture, usually originating from a single “shot”, meaning a sequence of continuous filming between scene changes. Further, although in various embodiments of the present invention, it is described herein that look data is generated for a scene or sequence of scenes, it should be noted that the invention is not so limited and in alternate embodiments of the present invention, look data can be generated for individual frames or sequences of frames. As such, the term scene throughout the teachings of this disclosure and in the claims should be considered interchangeable with the term frame.

Also, as used herein, the phrase “Look Data Management” refers to the preparation of look data in content creation, the transmission, and the application. Content creation may include, but is not limited to, the motion picture post processing stage, color correction, and so forth. Transmission may include, but is not limited to, transmission and/or carrier mediums, including, but not limited to, compact discs, standard definition digital video discs, BLU-RAY digital video discs, high definition digital video discs, and so forth.

Additionally, as used herein, the phrase “look data”, and term “metadata” as it relates to such look data, refers to data such as, for example, integer, non-integer values, and/or Boolean values, used for and/or otherwise relating to color manipulation, spatial filtering, motion behavior, film grain, noise, editorial, and tone mapping. Such look data and/or metadata may be used to control, turn on or turn off relating mechanisms for implementing the preceding, and to modify the functionality of such. Furthermore, look data and/or metadata may include a specification of a mapping table.

For example, in an embodiment directed to color manipulation, a color mapping table could be realized by means of a 1-D LUT (one-dimensional Look Up Table), a 3-D LUT (three-dimensional Look Up Table), and/or 3×3 LUTs. As an example, in the case of a 3-D LUT, such LUT is used to receive three input values, each value representing one color component, Red, Green, or Blue, and producing a predefined triplet of output values, e.g., Red, Green, and Blue, for each individual Red, Green, and Blue input triplet. In this case, the metadata from a content source to a content consumption device (e.g., a display device) would then include a LUT specification.

An alternate embodiment can include a mapping function such as, for example, circuitry and/or so forth for performing a “GOG” (Gain, Offset, Gamma), which is defined as follows:

Vout=Gain*(Offset+Vin)̂Gamma, for each color component.

In this case, the look data and/or metadata would include nine values, one set of Gain, Offset, and Gamma for each of the three color components. Look data is used to influence these mechanisms and there can be several sets of look data, in order to implement transmission/storage of not only one, but several looks.

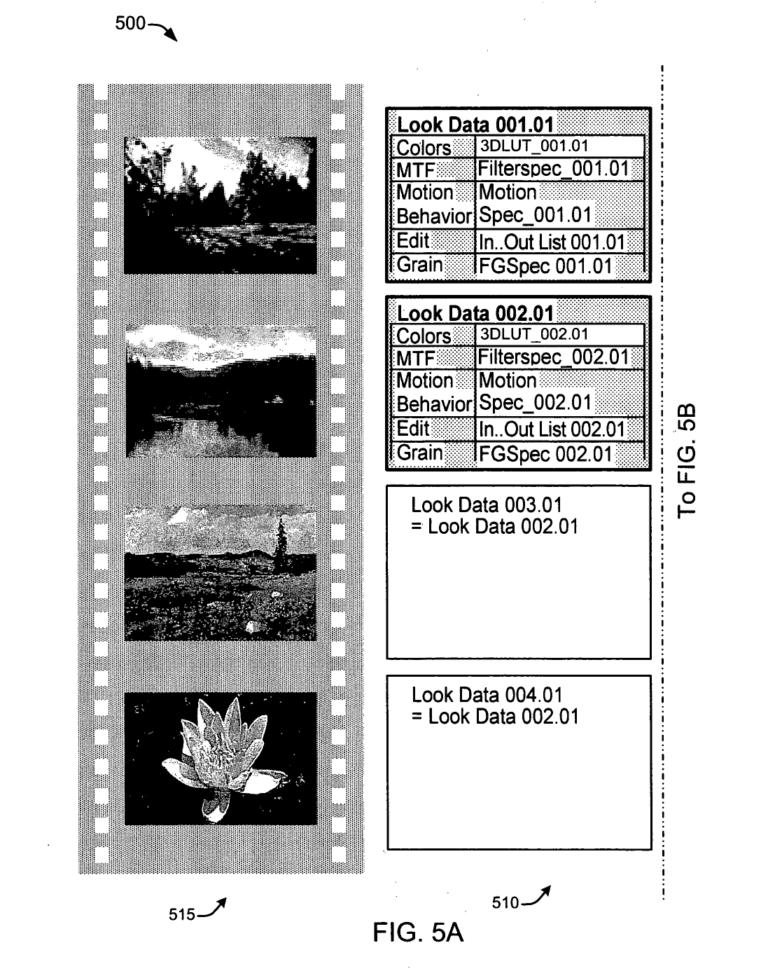

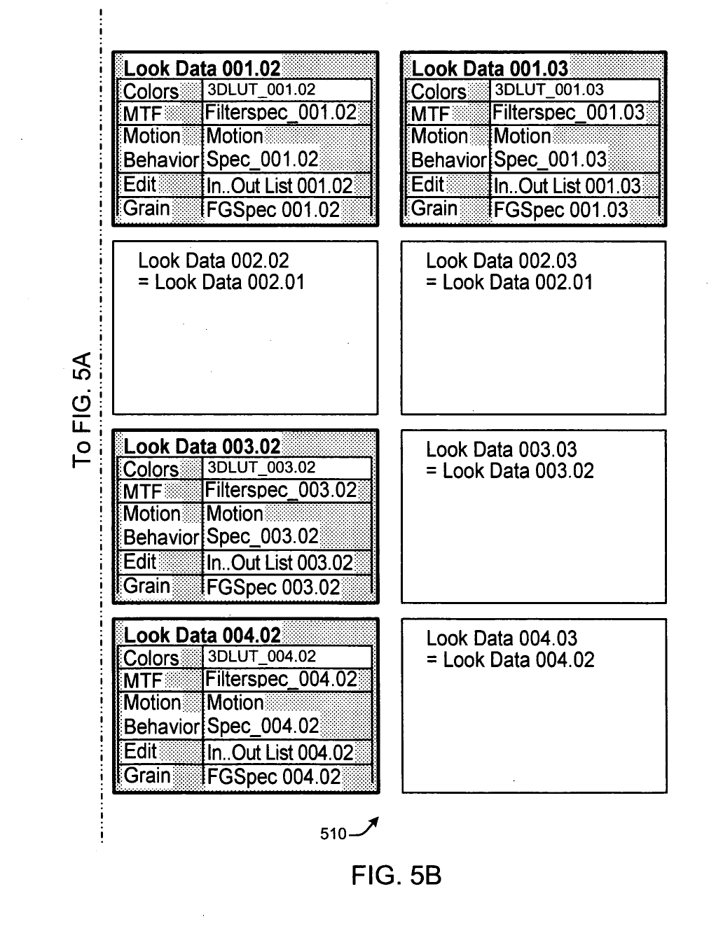

Of course, embodiments of the present invention are not limited to the preceding embodiments and, given the teachings of the present principles provided herein, other embodiments involving other implementations of look data and/or metadata are readily contemplated by one of ordinary skill in this and related arts, while maintaining the spirit of the present invention. Look data is further described herein at least with respect to FIG. 5.

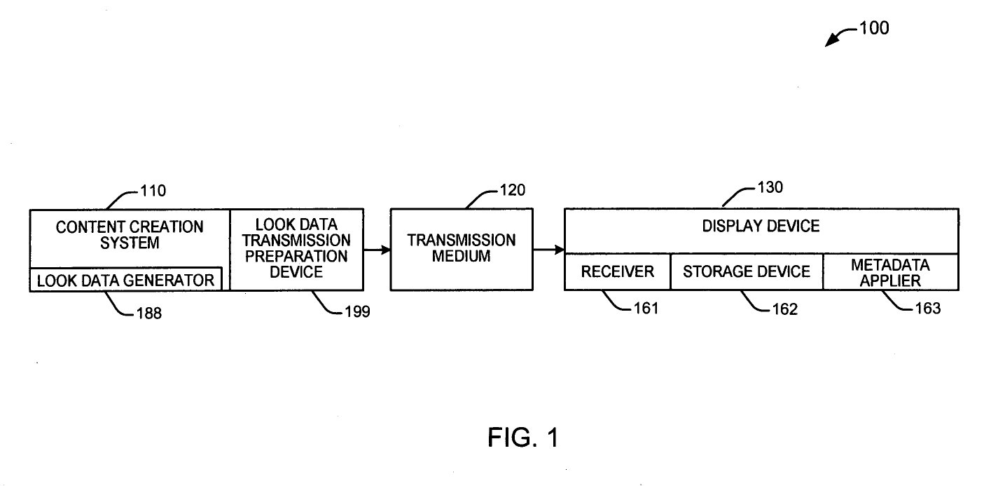

FIG. 1 depicts a high level block diagram of a system 100 for transmitting look data, in accordance with an embodiment of the present invention. The system 100 of FIG. 1 illustratively includes a content creation system 110, a transmission medium 120, and a display device 130. In one embodiment of the present invention, the content creation system 110 of system 100 includes a look data generator 188 for generating the look data 206 and a look data transmission preparation device 199 for preparing the look data 206 for transmission as further described below. It is to be appreciated that the transmission medium 120 can be, but is not limited to, a standard video disc, a high definition digital video disc, a BLU-RAY digital video disc, a network(s), and/or a network access unit (for example, including, but not limited to, a set top box (STB)). The content creation system 110 provides the content that is to be transmitted via transmission medium 120 to the display device 130 for display thereof. Metadata including, for example, look data (generated by a look data generator 177), can be provided from the content creation system 110 to the display device 130. In accordance with various embodiments of the present invention, the look data can be delivered/transmitted to the display device 130 either “in-band” or “out-of-band”.

It is to be appreciated that the display device 130 (or a device(s) disposed between the transmission medium 120 and the display device 130 and connected to these devices including, but not limited to, a set top box (STB)) can include a decoder (not shown) and/or other device(s) for depacketizing and decoding data received thereby.

The display device 130 (and/or a device(s) disposed between the transmission medium 120 and the display device 130 and connected to these devices) can include a receiver 161, a storage device 162, and/or a metadata applier 162 for respectively receiving, storing, and applying the metadata.

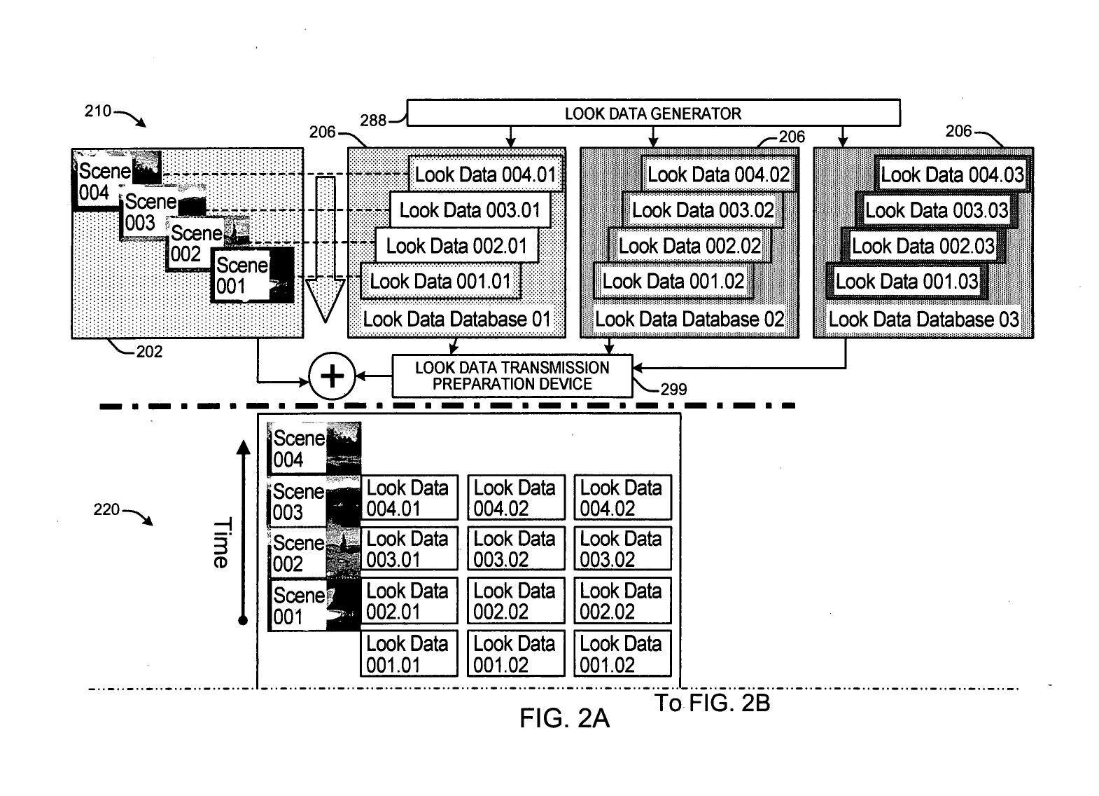

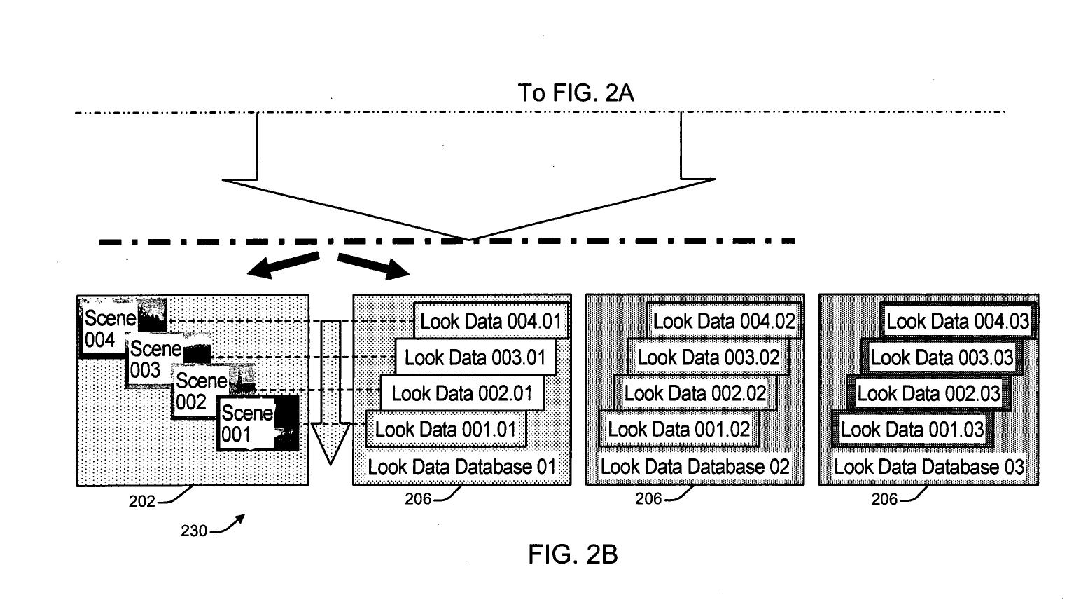

For example, FIG. 2 depicts a more detailed high level block diagram further illustrating the system 100 of FIG. 1 using sequential look data transmission, in accordance with an embodiment of the present invention. In the embodiment depicted in FIG. 2, the content 202 and a look data database 204 are disposed at a content authoring portion 210 of the system 100. The look database 204 is used for storing look data 206. In the embodiment of FIG. 2, the content authoring portion 210 of the system 100 includes a look data generator 288 for generating the look data 206 and a look data transmission preparation device 299 for preparing the look data 206 for transmission as further described below. The content 202 and the look data 206 are combined 207 at the content authoring portion 210. Using one or more transmission and/or storage mediums 220, the content 202 and corresponding look data 206 are transmitted in parallel to a content display portion 230 of the system 100, where the content 202 and the look data 306 are separated and processed. The content display portion 230 of the system 100 can include, for example, the display device 130 depicted in FIG. 1. The look data 206 can then be stored in a look data database 232 disposed at the content display portion 230 of the system 100. It should be appreciated that the transmission and/or storage mediums 220 depicted in FIG. 2 facilitate the parallel transmission and/or storage of the content 202 and/or look data 206.

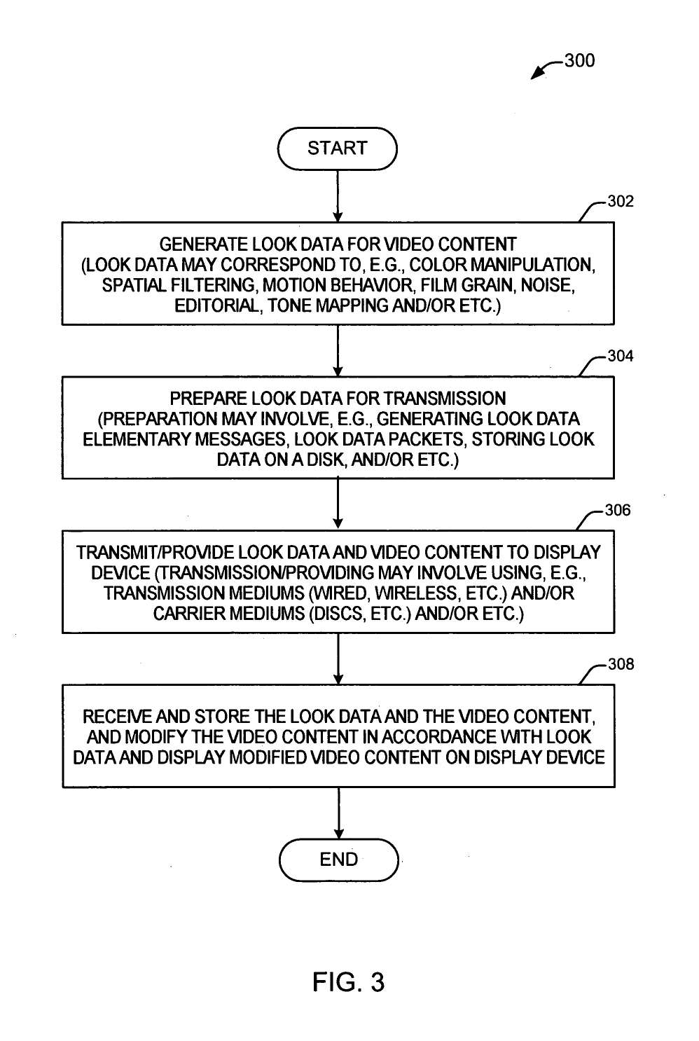

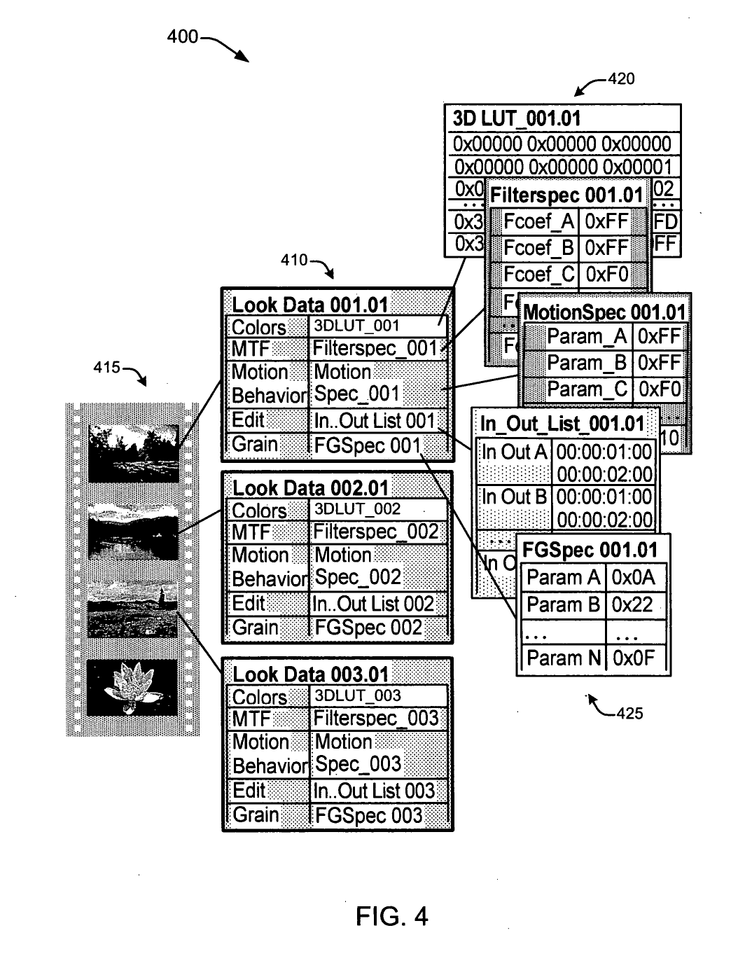

FIG. 3 depicts a flow diagram of a method for look data definition and transmission in accordance with an embodiment of the present invention. The method 300 of FIG. 3 begins at step 302, in which look data is generated for video content. Such look data can relate to, but is not limited to, color manipulation, spatial filtering, motion behavior, film grain, noise, editorial, tone mapping, and/or so forth. Such look data can be used to control, turn on or turn off relating mechanisms for implementing the preceding, and to modify the functionality of such. Embodiments of the look data of the present invention are described with regards to FIG. 4 below. The method 300 then proceeds to step 304.

At step 304, the look data is prepared for transmission, which in various embodiments can involve generating one or more Look Data Elementary Messages for the look data (previously generated at step 302), generating one or more look data packets that respectively include one or more Look Data Elementary Messages. Step 304 can optionally further include storing the look data packet on a disk. The method then proceeds to step 306.

At step 306, the look data packet and the video content are transmitted to a display device. Such transmission can involve, for example, transmission and carrier mediums. It is to be appreciated that the phrases “carrier mediums” and “storage mediums” are used interchangeably herein. Such transmission and carrier mediums include, but are not limited to Video over IP connections, cable, satellite, terrestrial broadcast wired mediums (e.g., HDMI, Display Port, DVI, SDI, HD-SDI, RCA, Separate Video (S-Video), and so forth), wireless mediums (e.g., radio frequency, infrared, and so forth), discs (e.g., standard definition compact discs, standard definition digital video discs, BLU-RAY digital video discs, high definition digital video discs, and so forth), and the like. The method then proceeds to step 308.

At step 308, the video content is received, stored, and/or modified in accordance with the look data and the modified video content is displayed on the display device. The method 300 can then be exited.

It is to be appreciated that the preceding order and use of received, stored, and modified video can vary depending on the actual implementation. For example, the type of storage can depend on the metadata being provided on a storage medium and/or can correspond to temporally storing the metadata on the content rendition side for subsequent processing.

Embodiments of the present invention enable the realization of different “looks” of content using look data and look data management as described in further detail below. Advantageously, through the use of look data which, in various embodiments is represented by metadata, the rendition of content with different looks (e.g., with variations in the parameters of the displayed content, which provide a perceivable visual difference(s) ascertainable to a viewer) is achieved. Moreover, embodiments of the present invention advantageously provide for the transmission of such look data to a consumer side (e.g., a set top box (STB), a display device, a DVD player), so that a final “look decision” (i.e., a decision that ultimately affects the way the content is ultimately displayed and thus perceived by the viewer) can be made at the consumer side by a viewer of such content.

One exemplary application of the described embodiments of the present invention is packaged media (e.g., discs), where content is created (e.g., for packaged media including, but not limited to for HD DVDs and/or BLU-RAY DVDs) using an encoding technique (e.g., including, but not limited to the MPEG-4 AVC Standard), and then look data in accordance with the present invention is added as metadata. This metadata can be used at the consumer side to control signal processing in, for example, a display device to alter the video data for display.

In addition, various exemplary methods for transmitting the look data are described herein. Of course, it is to be appreciated that embodiments of the present invention are not limited to solely the transmission methods described herein. Furthermore, it is to be appreciated that embodiments of the present principles can be used in a professional or semiprofessional environment including, but not limited to, processing “Digital Dailies” in motion picture production.

FIG. 4 depicts an exemplary representation of look data 400, in accordance with an embodiment of the present invention. The look data 400 of FIG. 4 illustratively includes look data packets 410, one for each scene or sequence of scenes 415. It should be noted that it is typically up to the content producer to define scene boundaries. As depicted in the embodiment of FIG. 4, each look data packet (LDP) 410 can include one or more Look Data Elementary Messages 420. Each Look Data Elementary Message (LDEM) includes parameters 425 that affecting at least one display attribute of the respective scene or sequence of scenes when the look data packets 410 are applied to a video signal by a signal processing unit for content rendering and/or display. More specifically, in accordance with embodiments of the present invention, the look data packets 410 and as such the Look Data Elementary Messages 420 and parameters 425 are intended to be delivered or communicated with respective video content to a display system including a content rendering device. At the display system, the content rendering device (e.g., decoder of a display or Set-top Box) applies the look data packets 410 to the respective video content to affect or change the display attributes of the scene or sequence of scenes for which the look data was created in accordance with the parameters in the Look Data Elementary Messages 420.

In one embodiment, the look data 400 can be shared among scenes 415 by not updating the look data 400 on scene changes if it is found that the look data 400 is equal between scenes 415. Thus, in one embodiment of the present invention, the look data 400 stays valid until the look data 400 is invalidated. For example, a subsequent look data packet intended to be applied to a subsequent scene or sequence of scenes can be flagged as empty using a message in the subsequent look data packet to force the use of the look data packet generated with respect to the previous scene or sequence of scenes.

FIG. 5 depicts another exemplary representation of look data 500, in accordance with an alternate embodiment of the present invention. In the embodiment of FIG. 5, the look data 500 can include, for example, a respective set (of two or more members) of look data packets, collectively denoted by the reference numeral 510, for each particular scene. Thus, several scenes, collectively denoted by the reference numeral 515, each respectively have their own set (of two or more members) of look data packets 510. For example, in one embodiment of the present invention, there can exist a plurality of look data packets that each respectively alter display attributes of the video content for a particular scene or sequence of scenes in different ways. Such look data packets can then be organized into 1 through N look data packets where each of the 1 through N look data packets respectively correspond to one of a plurality of looks. As such, all or some of the 1 through N look data packets can then be transmitted/delivered to receiver of a display system along with the video content.

It is to be appreciated, however, that if the look data is similar among the sets or among the scenes, then there may be no need for retransmission of entire or subsets of subsequent sets that are similar to previously transmitted sets. Thus, look data for a current scene being processed can be obtained and/or otherwise derived from, for example, a “neighboring left look data packet” or “a neighboring above look data packet” when the look data corresponding thereto is unchanged. In one embodiment, for example, a neighboring left look data packet can have a higher priority than a neighboring above look data packet.

It is to be further appreciated that for saving metadata payload, as noted above, it is preferable to avoid transmitting duplicate data (i.e., duplicate look data). Thus, in an embodiment of the present invention, look data does not have to be retransmitted among look versions (i.e., different looks for a same scene or sequence of scenes) if, for one particular scene, the look data among two or more versions are equal. In one embodiment, the sharing of metadata among versions shall have a higher priority over the sharing of metadata among scenes.

In the example of FIG. 5 described above, by providing a set of two or more members of look data packets for each scene or video content, in which each packet corresponds to a different look or color decision that can be made by a viewer, a user is able to dynamically select a preferred look at one time, and then other looks for the same video content at other times. That is, in accordance with the present invention, the same video content can be viewed by a viewer with visually perceptible differences that are selected by the viewer by selecting look data packets to be applied to the video content.

In one embodiment of the present invention, for transmission of the Look Data Packet of the present invention, the “KLV” (Key, Length, Value) metadata concept can be implemented however, other concepts can be applied. That is, while one or more embodiments are described herein with respect to the KLV metadata concept, it is to be appreciated that the present invention is not limited to the KLV concept, thus, other approaches for implementing the Look Data Packets can also be applied in accordance with the present invention.

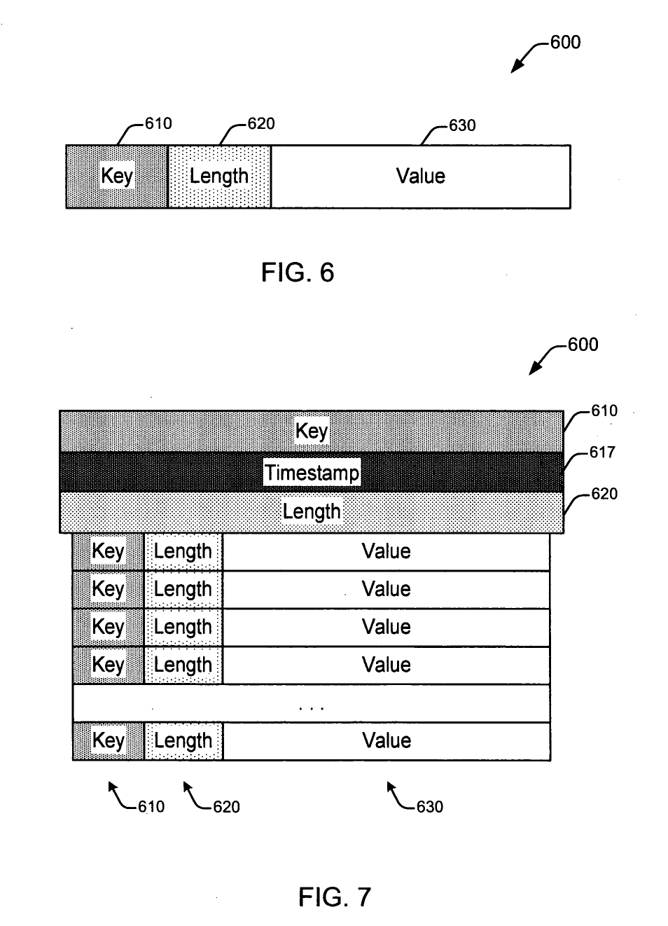

More specifically, the KLV concept is useful for transmission devices to determine when a transmission of a packet is complete without having to parse the content. Such a concept is illustrated with respect to FIG. 6 and FIG. 7.

For example, FIG. 6 depicts exemplary KLV notation of metadata 600 for use in Look Data Elementary Messages, in accordance with an embodiment of the present invention. FIG. 7 depicts the KLV notation of metadata 600 of FIG. 6 in further detail, in accordance with an embodiment of the present invention.

More specifically and referring to FIG. 6 and FIG. 7, each packet can include a “key” field 610 that indicates the nature of the message (i.e., that the message relates to “Look Data”). The key can include a time stamp 617 or, alternatively, a “scene ID”, such that a receiving device knows on which scene the data is intended for application. It should be noted that in various embodiments of the present invention, the time stamp 617 and/or scene ID are optional, and can be used, for example, for systems in which time code tracking is implemented.

In addition, each packet can include a length field 620 that indicates the number of words in the payload portion of the packet. Again, it should be noted that in various embodiments of the present invention, the length field 620 is optional, and its use can depend, for example, on a metadata tag.

Further, each packet can include a value field 630 for carrying the payload portion of the packet. In one embodiment, the word size of the payload contents can be determined by a metadata tag. In various embodiments, the payload can include, for example, individual “Look Data Elementary Messages”, where another layer of KLV can be used.

### Look Data Elementary Messages

The following are a few examples Look Data Elementary Messages in accordance with various embodiments of the present invention, however, should not be considered a complete listing of the Look Data Elementary Messages of the present invention.

1. Color Manipulation

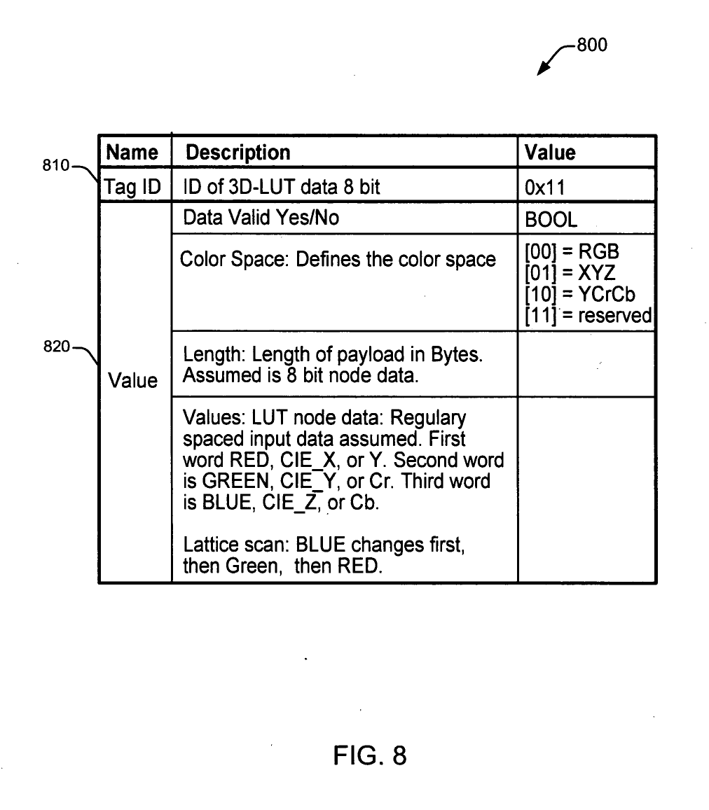

In one embodiment of the present invention, color manipulation can be defined in a Look Data Elementary Message. That is, color manipulation can be implemented, for example, by one or more 3D-LUT's, one or more 1D-LUT's, and/or one or more 3×3 LUT's. For example, an exemplary definition of such Look Data Elementary Messages is provided in FIG. 8 through FIG. 14.

More specifically, FIG. 8 depicts an exemplary Look Data Elementary Message 800 implemented as a 3D-LUT with a bit depth of 8 bits, in accordance with an embodiment of the present invention. As depicted in FIG. 8, the Look Data Elementary Message 800 includes a Tag ID section 810 and a Value section 820. The Value section 820 illustratively includes a validity section, a color space definition section, a length definition section, and a values section. Each of the sections of the Look Data Elementary Message 800 of FIG. 8 contains a respective Description and Name section. The Tag ID section 810 of FIG. 8 defines an 8 bit ID of the 3D-LUT, which is illustratively 0×11. In the Value section 820, the validity section defines if the data is valid or not and in FIG. 8 is illustratively defined in Boolean. In the Value section 820, the color spaced section defines the color space and in FIG. 8 is illustratively defined as [00]=RGB, [01]=XYZ, [10]=YCrCb, and [11]=reserved.

The length definition section in the Value section 820 of FIG. 8 defines a length of the payload in bytes, which is illustratively assumed to be 8 bit node data. In addition, the values section defines various values such as LUT node data, the spacing of the input data, which is illustratively assumed to be regularly spaced, word definitions and order, illustratively “first word RED, CIE_X or Y”, “second word is GREEN, CIE_Y, or Cr”, and “third word is BLUE, CIE_Z, or Cb”. In the Look Data Elementary Message 800 of FIG. 8, the values section also illustratively defines a Lattice scan of “BLUE changes first, then Green, then RED”.

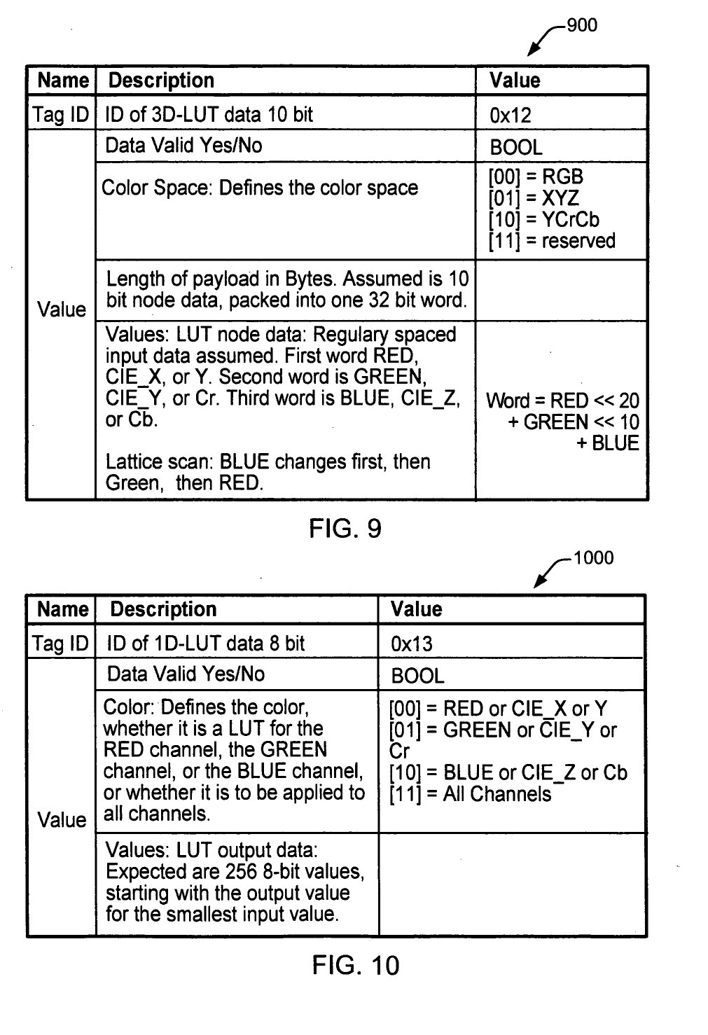

FIG. 9 depicts an exemplary Look Data Elementary Message 900 implemented as a 3D-LUT with a bit depth of 10 bits, in accordance with an embodiment of the present invention. The Look Data Elementary Message 900 of FIG. 9 is substantially similar to the Look Data Elementary Message 800 of FIG. 8 except that in FIG. 9, the ID of the 3D-LUT has a bit depth of 10 bits and having a value of 0×12. In addition, in the Look Data Elementary Message 900 of FIG. 9 the length definition defines a length of the payload illustratively assumed to be 10 bit node data, packed into one 32 bit word. Furthermore, in the embodiment of FIG. 9, the values section further defines the words “RED”, “GREEN” and “BLUE” as follows:

Word=RED<<20+GREEN<<10+BLUE.

FIG. 10 depicts an exemplary Look Data Elementary Message 1000 implemented as a 1D-LUT with a bit depth of 8 bits, in accordance with an embodiment of the present invention. In the Look Data Elementary Message 1000 of FIG. 10, the ID of the 1D-LUT has a bit depth of 8 bits with a value of 0×13. Different from the Look Data Elementary Messages of FIG. 8 and FIG. 9 above, in the Look Data Elementary Message 1000 of FIG. 10 the color definition section defines the color, whether it is a LUT for the RED channel, the GREEN channel, or the BLUE channel, or whether the LUT is to be applied to all channels. In FIG. 10, the color values are illustratively defined as [00]=RED or CIE_X or Y, [01]=GREEN or CIE_Y or Cr, [10]=BLUE or CIE_Z or Cb, and [11]=All channels. In addition, in the Look Data Elementary Message 1000 the values section defines that the LUT output data is expected to be 256 8-bit values starting with the output value for the smallest input value.

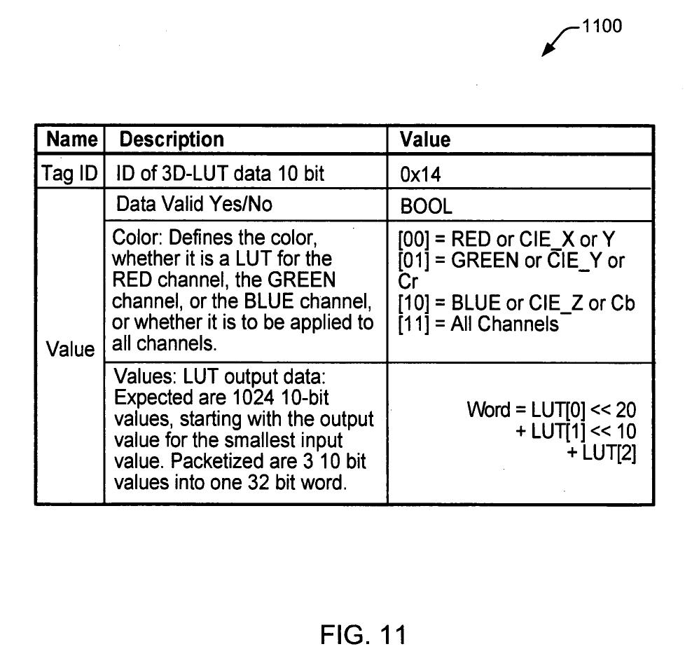

FIG. 11 depicts an exemplary Look Data Elementary Message 1100 implemented as a 1D-LUT with a bit depth of 10 bits, in accordance with an embodiment of the present invention. The Look Data Elementary Message 1100 of FIG. 11 is substantially similar to the Look Data Elementary Message 1000 of FIG. 10 except that in the embodiment of FIG. 11, the Look Data Elementary Message 1100 comprises an ID having a bit depth of 10 bits having a value of 0×14. In addition, in the Look Data Elementary Message 1100 the values section defines that the LUT output data is expected to be 1024 10-bit values starting with the output value for the smallest input value and that packetized are three, 10-bit values into one 32 bit word having values as follows:

Word=LUT[0]<<20+LUT[1]<<10+LUT[2].

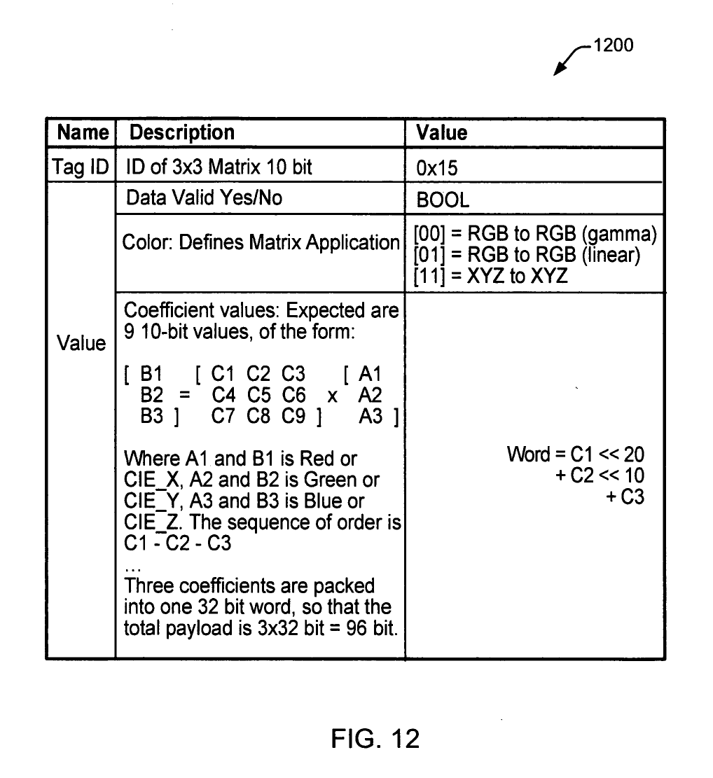

FIG. 12 depicts, an exemplary Look Data Elementary Message 1200 implemented as a 3×3 matrix with a bit depth of 10 bits, in accordance with an embodiment of the present invention. In the Look Data Elementary Message 1200 the color definition defines a matrix application having values of [00]=RGB to RGB (gamma), [01]=RGB to RGB (linear) and [11]=XYZ to XYZ. In addition, in the Look Data Elementary Message 1200 of FIG. 12, the values section defines coefficient values expected as nine, 10-bit values in the form:

$$\begin{matrix}[ B 1 \\ B 2 \\ B 3 ]\end{matrix} = \begin{matrix}[ C 1 & C 2 & C 3 \\ C 4 & C 5 & C 6 \\ C 7 & C 8 & C 9 ]\end{matrix} \times \begin{matrix}[ A 1 \\ A 2 \\ A 3 ]\end{matrix}$$

where A1 and B1 is RED or CIE_X, A2 and B2 is GREEN or CIE_Y, and A3 and B3 is BLUE or CIE_Z and the sequence of order is C1-C2-C3. In the Look Data Elementary Message 1200 of FIG. 12, the values section defines that the three coefficients are packed into one, 32-bit word so that the total payload is 3×32 bit=96 bits having values as follows:

Word=C1<<20+C2<<10+C3.

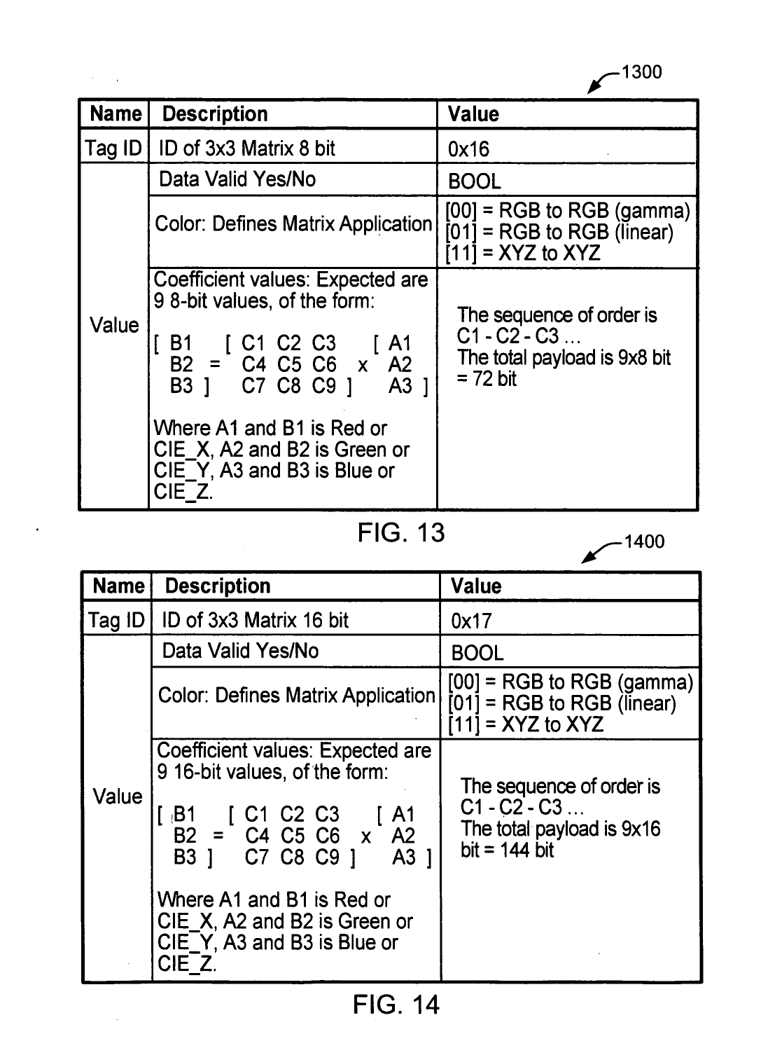

FIG. 13 depicts an exemplary Look Data Elementary Message 1300 implemented as a 3×3 matrix with a bit depth of 8 bits, in accordance with an embodiment of the present invention. The Look Data Elementary Message 1300 of FIG. 13 is substantially similar to the Look Data Elementary Message 1200 of FIG. 12 except that in the embodiment of FIG. 13, the Look Data Elementary Message 1300 comprises an ID having a bit depth of 8 bits having a value of 0×16. In addition, in the Look Data Elementary Message 1300 of FIG. 13 the total payload is 9×8 bit=72 bits.

FIG. 14 depicts an exemplary Look Data Elementary Message 1400 implemented as a 3×3 matrix with a bit depth of 16 bits, in accordance with an embodiment of the present principles. The Look Data Elementary Message 1400 of FIG. 14 is substantially similar to the Look Data Elementary Message 1200 of FIG. 12 and the Look Data Elementary Message 1300 of FIG. 13 except that in the embodiment of FIG. 14, the Look Data Elementary Message 1400 comprises an ID having a bit depth of 16 bits having a value of 0×17. In addition, in the Look Data Elementary Message 1400 of FIG. 14 the total payload is 9×16 bit=144 bits.

2. Spatial Filter

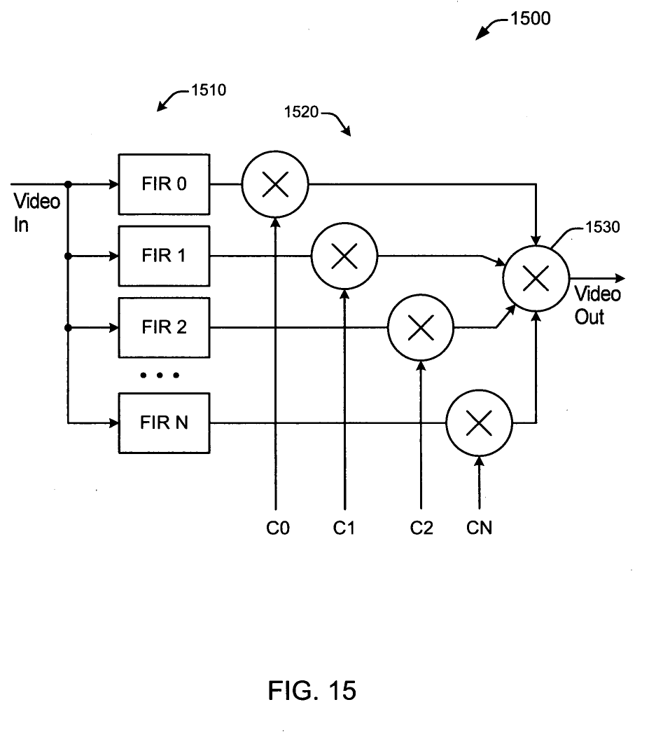

In an embodiment of the present invention, spatial filtering control can be specified in a Look Data Elementary Message. For example, the spatial response or frequency response can be altered using spatial domain filtering. One exemplary method of changing the spatial frequency response is to use a bank of finite impulse response (FIR) filters, each tuned to one particular center frequency. FIG. 15 depicts an exemplary filter bank 1500 for frequency response modification, in accordance with an embodiment of the present invention. The filter bank 1500 of FIG. 15 illustratively includes a plurality of filters 1510, at least one multiplier 1520, and at least one combiner 1530.

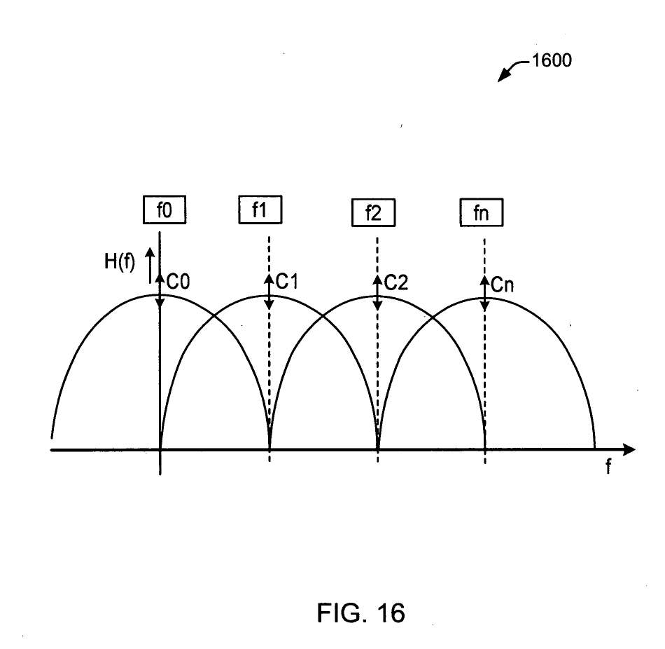

In one embodiment, the frequency response of a picture is manipulated by changing the filter coefficients (C0 . . . CN), in order to enhance or attenuate a frequency detail. For example, FIG. 16 depicts exemplary discrete frequencies 1600 for frequency equalization, in accordance with an embodiment of the present invention. As depicted in FIG. 16, the filter coefficients (C0 . . . CN) can be specified with the Look Data Elementary Message for frequency response.

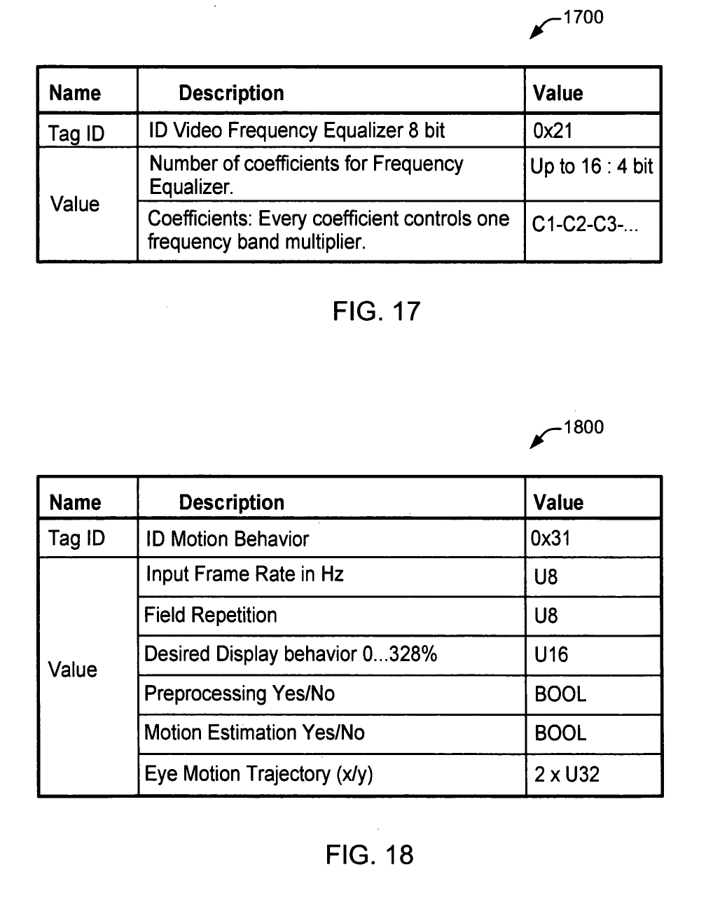

an exemplary Look Data Elementary Message 1700 for 8 bit frequency equalization, in accordance with an embodiment of the present invention. As depicted in the embodiment of FIG. 17, the Look Data Elementary Message 1700 defines a number of coefficients for the frequency equalizer, for example, up to 16, 4 bit, and defines that every coefficient controls one frequency band multiplier.

3. Motion Behavior

In one embodiment, motion behavior control can be specified in a Look Data Elementary Message, utilizing a message that contains information for allowing the display to align the motion behavior to a desired motion behavior. This information carries the specification of the desired motion behavior, and additionally can carry helper data from a content preprocessing unit that simplifies processing in the display. For example, FIG. 18 depicts an exemplary Look Data Elementary Message 1800 for motion behavior, in accordance with an embodiment of the present invention. The Look Data Elementary Message 1800 of the embodiment of FIG. 18 illustratively defines an input frame rate in HZ (U8), a field repetition (U8), a desired display behavior (U16), and an eye motion trajectory in x/y (2×U32). In addition, in the Look Data Elementary Message 1800 of the embodiment of FIG. 18 it is defined whether preprocessing or motion estimation exists.

4. Film Grain

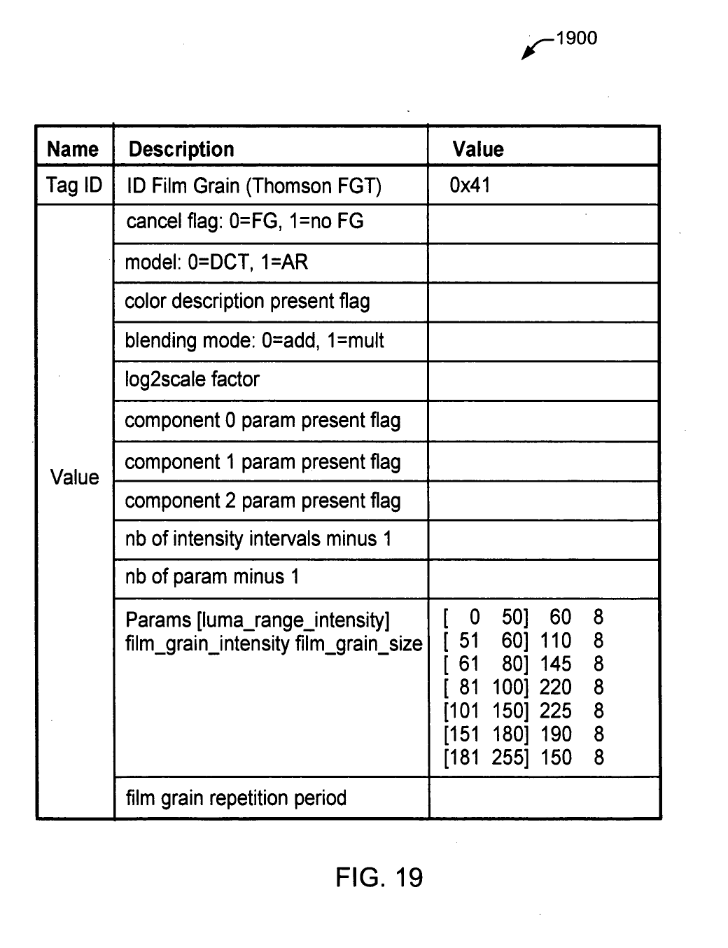

In an embodiment, film grain control can be specified in a Look Data Elementary Message. In one embodiment of the present invention, the film grain message can be taken from the MPEG-4 AVC Standard, payload type=19. FIG. 19 depicts an exemplary Look Data Elementary Message 1900 for film grain, in accordance with an embodiment of the present invention.

5. Noise

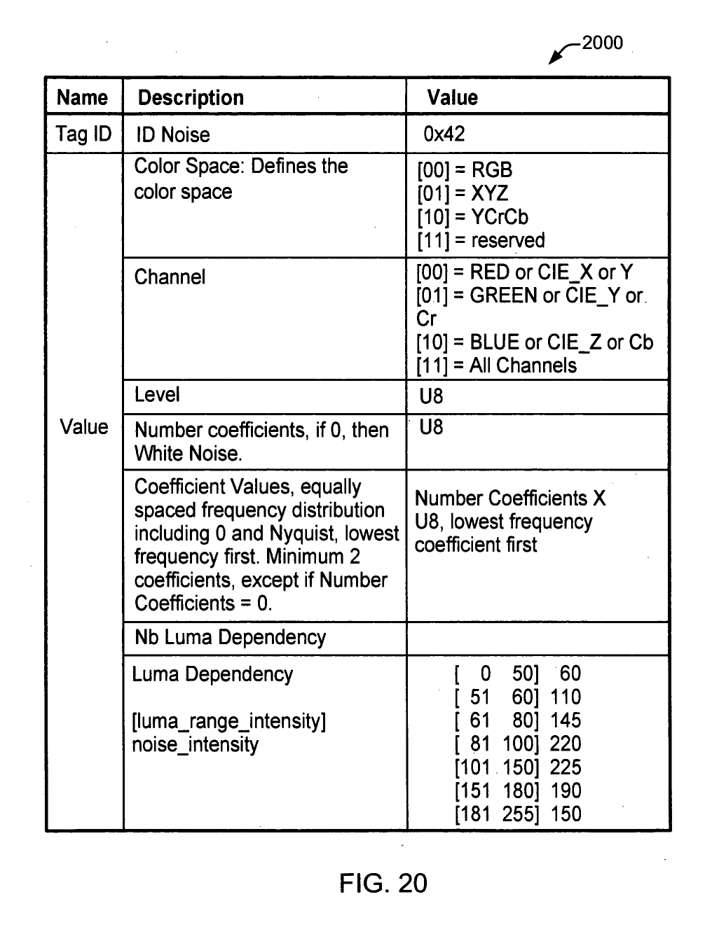

In an embodiment, noise control can be specified in a Look Data Elementary Message. That is, it is possible to add a determined level of White Noise, same to all color channels, or one particular level/behavior per channel within the Look Data Elementary Message for noise. Moreover, in an embodiment, noise can be removed from one or more color channels. In one embodiment, the noise characteristic can be changed by modifying the frequency response in the same manner as the spatial response, as described above. FIG. 20 depicts an exemplary Look Data Elementary Message 2000 for noise, in accordance with an embodiment of the present invention.

6. Editorial

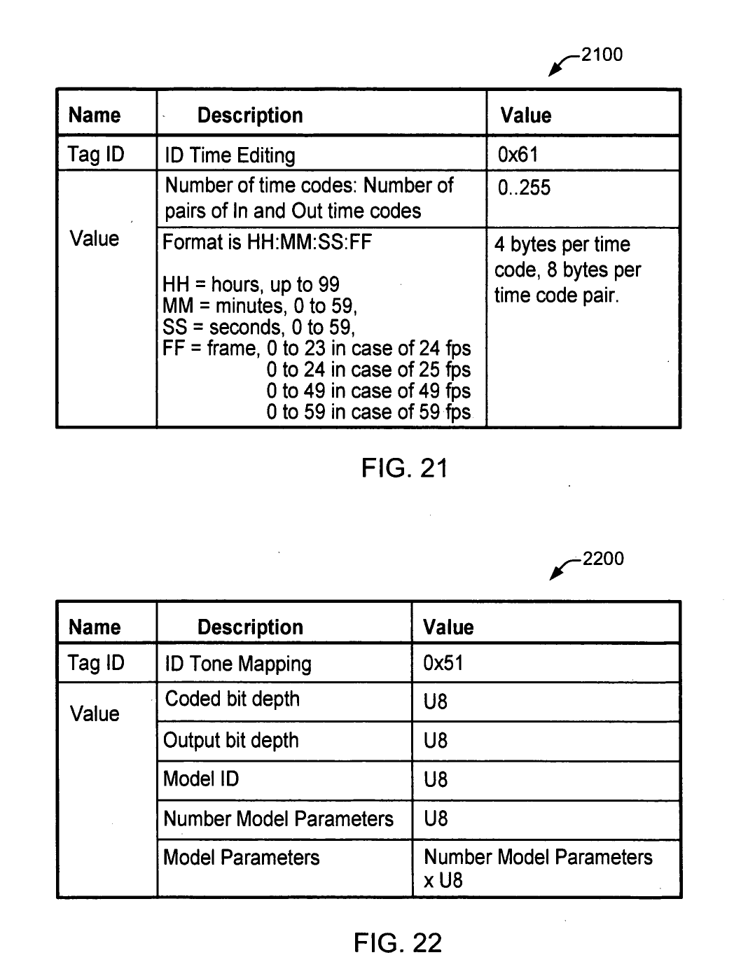

In an embodiment, the editorial of one or more scenes can be specified in a Look Data Elementary Message. For example, it is possible to cut out one or more segments of a scene or groups of scenes in accordance with a Look Data Elementary Message of the present invention. As such, the cut scene can be displayed at a later time with an update of the Editorial data. Thus, in an embodiment, a “cut list” of IN and OUT time codes within a particular scene can be transmitted. In one embodiment, the first frame of a scene would have the time code 00:00:00:00 (HH:MM:SS:FF). FIG. 21 depicts an exemplary Look Data Elementary Message 2100 for time editing capable of being used for editorial control, in accordance with an embodiment of the present invention.

7. Tone Mapping

In one embodiment, tone mapping is specified in a Look Data Elementary Message. Tone mapping can be used, for example, when converting a high dynamic range image to a low dynamic range image. As an example, a typical application could be the conversion from a 10 bit encoded image to an 8 bit or 7 bit image. It is to be appreciated that the present principles are not limited to any particular tone mapping algorithm and, thus, any approach to tone mapping can be used in accordance with the present invention, while maintaining the spirit of the present principles. As one example, tone mapping can be specified in a supplemental enhancement information (SEI) message in the MPEG-4 AVC Standard. For example, FIG. 22 depicts an exemplary Look Data Elementary Message 2200 for tone mapping, in accordance with an embodiment of the present invention. The Look Data Elementary Message 2200 of FIG. 22 is capable of specifying parameters that are also capable of being specified in an SEI message.

In accordance with the principles of the various embodiments of the present invention, the look data should be available for rendering/display with the start of a scene. In one embodiment, look data can be transmitted to a receiver, for example, using the metadata channel of a physical transmission interface for uncompressed video. Such physical transmission interface can include a high definition multimedia interface (HDMI), display port, serial digital interface (SDI), high definition serial digital interface (HD-SDI), universal serial bus (USB), IEEE 1394, and other known transmission means. In alternate embodiments of the present invention, look data can be transmitted using secondary connections in parallel to the video connection. Such secondary connections can include USB, RS-232, Ethernet, Internet Protocol (IP), and the like. In addition, in various embodiments of the present invention, the look data of the present invention can be transmitted between devices using a wireless protocol including such, BLUETOOTH, WIFI, and the like. Even further, the look data of the present invention can also be transmitted in an MPEG stream using SEI (Supplemental Enhancement Information) tags, as defined by the Joint Video Team (JVT).

Having described preferred embodiments for a method and system for look data definition and transmission (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for generating look data for video content, comprising:
generating look data for a scene or sequence of scenes of the video content, wherein the look data includes at least one control parameter for affecting at least one display attribute of the respective scene or sequence of scenes of the video content; and
generating at least one look data packet from the look data, the at least one look data packet intended to be delivered with the video content to enable the at least one look data packet to be applied to the video content.

2. The method of claim 1, further comprising delivering the video content and the at least one look data packet to a display system.

3. The method of claim 2, wherein a content rendering device of the display system applies the at least one look data packet to the video content to change the at least one display attribute of the video content in accordance with the at least one control parameter of the at least one look data packet.

4. The method of claim 2, wherein only a portion of a subsequent look data packet is delivered to the display system when only the portion of the subsequent look data packet has changed for a current scene or sequence of scenes relative to a look data packet generated for a previous scene or sequence of scenes.

5. The method of claim 1, wherein the at least one display attribute comprises at least one of color of the video content, spatial filtering of the video content, a motion behavior of the video content, a film grain attribute of the video content, noise in the video content, an editorial of a scene in the video content, and tone mapping with respect to the video content.

6. The method of claim 1, wherein the video content and the at least one look data packet are recorded on a recordable disk medium.

7. The method of claim 1, wherein the video content and the at least one look data packet are delivered to a receiver using at least one of a high definition multimedia interface (HDMI), a display port, a serial digital interface (SDI), a high definition serial digital interface (HD-SDI), a universal serial bus (USB), an IEEE interface, a USB interface, RS-232, Ethernet, Internet Protocol (IP), BLUETOOTH, WIFI, Supplemental Enhancement Information (SEI) messaging, cable and satellite.

8. The method of claim 1, comprising generating more than one look data packet for a scene or sequence of scenes, wherein each look data packet comprises at least one different control parameter for a display attribute of the video content such that, when applied to the video content, each look data packet causes a different look for the respective scene or sequence of scenes of the video content when displayed.

9. The method of claim 8, wherein the more than one look data packets are organized into 1 through N look data packets, N being an integer, where each of the 1 through N look data packets respectively corresponds to one of a plurality of looks for the respective scene or sequence of scenes of the video content.

10. The method of claim 9, wherein a particular one of the 1 through N packets corresponding to a particular one of the plurality of looks for the respective scene or sequence of scenes of the video content is omitted when a preceding one of the 1 through N packets corresponding to another one of the plurality of looks for the respective scene or sequence of scenes of the video content is substantially the same to force a use of the preceding one of the 1 through N packets for the display of the particular one of the plurality of looks for the respective scene or sequence of scenes of the video content.

11. The method of claim 1, wherein respective look data is generated to compensate for variations in display attributes of different display devices such that when a respectively generated look data packet is applied to video content to be displayed on a display device for which the look data packet was created, the video content when displayed contains the display attributes intended by a creator of the video content.

12. The method of claim 1, wherein the look data packet remains valid for application to subsequent scenes or sequence of scenes until the look data packet is invalidated.

13. A system for generating look data for video content, comprising:
a metadata generator for generating look data for a scene or sequence of scenes of the video content, wherein the look data includes at least one control parameter for affecting at least one display attribute of the respective scene or sequence of scenes of the video content; and
a metadata transmission preparation device for generating at least one look data packet from the look data, the at least one look data packet intended to be delivered with the video content to enable the at least one look data packet to be applied to the video content.

14. The system of claim 13, further comprising a transmission medium for delivering the video content and the at least one look data packet to a display system.

15. The system of claim 14, wherein the display system comprises a content rendering device for applying the at least one look data packet to the video content to change the at least one display attribute of the scene or sequence of scenes of the video content in accordance with the at least one control parameter of the at least one look data packet.

16. The system of claim 14 wherein said transmission medium comprises a recordable storage medium.

17. The system of claim 14, wherein said transmission comprises at least one of a high definition multimedia interface (HDMI), a display port, a serial digital interface (SDI), a high definition serial digital interface (HD-SDI), a universal serial bus (USB), an IEEE interface, a USB interface, RS-232, Ethernet, Internet Protocol (IP), BLUETOOTH, WIFI, Supplemental Enhancement Information (SEI) messaging, cable and satellite.

18. The system of claim 14, wherein only a portion of a subsequent look data packet is delivered to the display system when only the portion of the subsequent look data packet has changed for a current scene or sequence of scenes relative to a look data packet generated for a previous scene or sequence of scenes.

19. The system of claim 13, wherein said metadata generator generates more than one look data packet for a scene or sequence of scenes, wherein each look data packet comprises at least one different control parameter for a display attribute of the video content such that, when applied to the video content, each look data packet causes a different look for the respective scene or sequence of scenes of the video content when displayed.

20. The system of claim 13, further comprising a storage device for storing the video content and the look data packet on a recordable disk.

21. The system of claim 13, wherein said metadata transmission preparation device prepares the look data packet for transmission in a Supplemental Enhancement Information message.

22. A storage media having video signal data encoded thereupon, comprising:
at least one look data packet for at least one scene or sequence of scenes of video content, wherein the at least one look data packet includes at least one control parameter for affecting at least one display attribute of the respective scene or sequence of scenes of the video content such that when the at least one look data packet is applied to the video content at least one display attribute of the video content is changed in accordance with the at least one control parameter of the at least one look data packet.
